(19) United States
(12) Patent Application Publication
(10) Pub. No.: US 2026/0104042 A1
(43) Pub. Date: Apr. 16, 2026

(54) PUMP

(71) Applicant: TOYOTA JIDOSHA KABUSHIKI KAISHA, Toyota-shi (JP)

(72) Inventor: Taro TSUKADA, Sunto-gun (JP)

(73) Assignee: TOYOTA JIDOSHA KABUSHIKI KAISHA, Toyota-shi (JP)

(21) Appl. No.: 19/227,955

(22) Filed: Jun. 4, 2025

(30) Foreign Application Priority Data
Oct. 11, 2024 (JP) 2024-178729

(51) Int. Cl. F04B 43/08; B64C 31/06

(52) U.S. Cl. CPC F04B 43/084; B64C 31/06

(57) ABSTRACT

A pump configured to deliver a fluid in one direction includes a bag-shaped storage chamber formed of an expandable and contractible flexible material for storing a fluid, an expansion and contraction unit for expanding and contracting the storage chamber, an intake check valve communicating with the inside of the storage chamber and allowing only the flow of the fluid from the outside to the inside of the storage chamber, and an discharge check valve communicating with the inside of the storage chamber and allowing only the flow of the fluid from the inside to the outside of the storage chamber, and when the storage chamber expands by the expansion and contraction unit, the fluid flows into the storage chamber through the intake check valve, and when the storage chamber contracts by the expansion and contraction unit, the fluid flows out from the storage chamber through the discharge check valve.

### CROSS-REFERENCE TO RELATED APPLICATION

This application claims priority to Japanese Patent Application No. 2024-178729 filed on Oct. 11, 2024. The disclosure of the above-identified application, including the specification, drawings, and claims, is incorporated by reference herein in its entirety.

### BACKGROUND

### 1. Technical Field

The present disclosure relates to a pump for pumping a fluid in one direction, and more particularly, to a pump that is configured to deliver fluid in one direction by expanding and contracting a bag-shaped structure body.

### 2. Description of Related Art

In various types of mechanical equipment, a mechanism for displacing a movable portion by expanding and contracting a bag-shaped structure body that is linked to the movable portion is used. For example, Japanese Unexamined Patent Application Publication No. 2022-91738 (JP 2022-91738 A) proposes a brake mechanism for a wheel of a personal mobility device. Instead of a mechanical hydraulic brake, the mechanism applies a braking force to the wheel by electrically deforming an artificial muscle, which is a bag-shaped structure body containing a dielectric fluid therein, so as to expand the artificial muscle. Also, Japanese Unexamined Patent Application Publication No. 2022-95084 (JP 2022-95084 A) proposes a deformation mechanism of a frame member of a flying object including a wing portion that is made of an elastically deformable frame member and a membrane-like member that is stretched over the frame member, and generates lift force under wind pressure. The mechanism uses a McKibben-type artificial muscle that allows compressed air from a compressor to enter inside the bag-shaped structure body and exit therefrom, causing the bag-shaped structure body to expand and contract.

### SUMMARY

Incidentally, an inflatable structure, which is a structure in which air is injected into a bag-shaped structure body to be inflated and the shape is maintained at an internal pressure, is lightweight. This is used in various applications such as wings of flying objects, and other structures such as inflatable kites and inflatable boats, building structures such as dome roofs and disaster evacuation shelters, road structures such as pylons and traffic regulating members, toys, playground equipment, objects, and so forth that are filled with air and expanded, such as balls. In such inflatable structures, air leakage from an outer skin of the structure body may cause a decrease in internal pressure when being operated over prolonged periods of time. As a result, the shape cannot be maintained, and thus a mechanism for timely delivery of compressed air into the bag-shaped structure body is sometimes provided. When no compressed air delivery mechanism is installed on the bag-shaped structure body, usage of the inflatable structure needs to be interrupted and work for pressurizing the inside of the bag-shaped structure body to be performed in a timely manner. In a compressed air delivery mechanism for such an inflatable structure, a pump device such as a compressor is usually disposed in the vicinity of the bag-shaped structure body, such as in JP 2022-95084 A, for example. When the position or shape of the structure body is changed in industrial usage or in a sports recreation scene, or when air is removed from the bag-shaped structure body when the inflatable structure is folded and stored, the outer skin of the bag-shaped structure body and the pump device may rub against each other. In order not to damage the outer skin of the bag-shaped structure body, it is advantageous for the pump device to have a flexible configuration, rather than being rigid. Further, in the case of a structure body to be raised overhead such as an inflatable kite, it may be difficult to install a power supply device or an electric pump device therein, due to weight limit. In recreation and disaster readiness, securing a power supply device for the pump may be difficult.

In view of the above-described circumstances, a primary object of the present disclosure is to provide a pump of a novel structure that is suitable for injecting air into a bag-shaped structure body of an inflatable structure, that has a structure which is relatively flexible and does not readily damage the outer skin even when rubbing against the outer skin of the bag-shaped structure body, and that is capable of executing pumping operations of air without direct power supply.

According to the present disclosure, in one aspect, the above object is achieved by a pump that is configured to deliver fluid in one direction, the pump including
a storage chamber that has a bag shape and is made of an expandable and contractible flexible material for storing fluid,
an expansion and contraction unit for expanding and contracting the storage chamber,
an intake check valve that communicates with an interior of the storage chamber to only allow flow of fluid from outside of the storage chamber to inside of the storage chamber, and
a discharge check valve that communicates with the interior of the storage chamber to only allow flow of fluid from the inside of the storage chamber to the outside of the storage chamber, in which
when the storage chamber is expanded by the expansion and contraction unit, fluid flows into the storage chamber through the intake check valve, and
when the storage chamber is contracted by the expansion and contraction unit, fluid flows out from inside the storage chamber through the discharge check valve.

In the above configuration, the fluid may be any fluid, such as air, water, or the like. The “storage chamber that has a bag shape” is made of an expandable and contractible flexible material that is capable of storing fluid therein. Specifically, it may be made of any elastic material, for example a stretchable rubber-like material having strength capable of withstanding the internal pressure during the storage of fluid in the storage chamber. The “expansion and contraction unit” may be a unit for expanding or contracting the storage chamber that has a bag shape, by any mechanism. In one aspect, a mechanism may be adopted in which, for example, when mechanical force is placed on the storage chamber by the expansion and contraction unit, the storage chamber contracts or expands, and when application of the mechanical force on the storage chamber is eased by the expansion and contraction unit, the storage chamber expands or contracts due to elasticity thereof. As described above, the interior of the storage chamber communicates with the intake check valve that only allows flow of the fluid from the outside of the storage chamber to the inside of the storage chamber and the discharge check valve that only allows flow of the fluid from the inside of the storage chamber to the outside of the storage chamber. The intake check valve and the discharge check valve may be incorporated in a tubular path through which fluid flows into and out of the storage chamber.

According to the above-described configuration of the present disclosure, when the storage chamber is expanded by the expansion and contraction unit, the fluid flows into the storage chamber through the intake check valve. When the storage chamber is contracted by the expansion and contraction unit, the fluid flows out from the storage chamber through the discharge check valve. This allows fluid to be delivered in one direction from upstream of the intake check valve to downstream of the discharge check valve. Such a configuration basically includes a storage chamber that has a bag shape and that is made of a flexible material, an intake check valve and a discharge check valve communicating with inside of the storage chamber, and an expansion and contraction unit for expanding and contracting the storage chamber, by any system. Unlike a mechanical device having a rigid housing such as a compressor as in conventional arrangements, a configuration can be made that is relatively flexible and in which the outer skin is not readily damaged even when rubbing against the outer skin of the bag-shaped structure body of the inflatable structure. A configuration can be adopted in which pumping operations of air are executed without direct power supply. An advantage can be obtained in that disposing a power supply device in the vicinity of the pump is not necessary.

The configuration of the pump according to the present disclosure described above may be utilized to feed fluid to the bag-shaped structure body of the inflatable structure, as already mentioned. In this case, an outflow port (downstream side) of the fluid in the discharge check valve may be communicated into the bag-shaped structure body of the inflatable structure, and the pump may be configured to feed the fluid into the bag-shaped structure body by expanding and contracting of the storage chamber. Note that the intake check valve may be in communication with a fluid source, and may be open to the atmosphere when the fluid is air.

Specifically, with respect to the expanding and contracting of the storage chamber by the expansion and contraction unit of the above-described configuration,
the expansion and contraction unit may be configured to apply deformation force to the storage chamber, and
the pump may be configured such that
   when the deformation force from the expansion and contraction unit is applied, the storage chamber is deformed and volume inside the storage chamber decreases, and
   when the deformation force from the expansion and contraction unit is eased, the storage chamber is relaxed and the volume inside the storage chamber increases.

For example, in one embodiment, the storage chamber is a bag-shaped structure body that is made of an elastic material and has a cylindrical, elliptical spherical, or fusiform, outer shape. The expansion and contraction unit is a mesh-like tube surrounding the storage chamber. The bag-shaped structure body is configured to radially expand the tubular expansion and contraction unit by its elastic force. When both ends of the tubular expansion and contraction unit are pulled in directions away from each other, the tube shape is extended in a longitudinal direction and the diameter is contracted. At the same time, the storage chamber extends in the longitudinal direction, and the diameter contracts, thereby reducing the volume in the storage chamber. When the pulling of both ends of the tubular expansion and contraction unit is eased, the inner diameter of the tube shape and the storage chamber of the expansion and contraction unit is expanded while contracting in the longitudinal direction by the elastic force of the storage chamber as described above. The volume in the storage chamber will increase.

A configuration in which the expansion and contraction unit applies deformation force to the storage chamber, or more specifically, a configuration in which both ends of the tubular expansion and contraction unit are pulled, may be achieved in any manner.

In one aspect,
the expansion and contraction unit is linked to the inflatable structure, and
the pump may be configured such that changing a position of the inflatable structure changes the deformation force that is applied to the storage chamber from the expansion and contraction unit, or pulling force at both ends of the tubular expansion and contraction unit, and the fluid is fed into the bag-shaped structure body of the inflatable structure.

Note that in this configuration, an optional configuration that suppresses the expansion and contraction unit from applying deformation force to the storage chamber may be provided, so that when the internal pressure of the bag-shaped structure body of the inflatable structure reaches a predetermined pressure that is appropriately set, overpressure in the bag-shaped structure body can be suppressed. As for such a configuration, a configuration in which between both ends of the tubular expansion and contraction unit is locked (retained) when the internal pressure of the bag-shaped structure body reaches a predetermined pressure, may be used. Also, a configuration may be provided in which the position of the inflatable structure is periodically displaced, actively or autonomously, when the internal pressure of the bag-shaped structure body of the inflatable structure falls below a lower limit pressure that is appropriately set. As a result, the expansion and contraction unit periodically applies deformation force to the storage chamber.

The above-described pump of the present disclosure may advantageously be used for pumping air to the inflatable structure of a flying object moored to a ground surface by a main rope and raised overhead. In this case, the expansion and contraction unit of the pump of the present disclosure is linked to the main rope that moors the flying object, and deformation force from the expansion and contraction unit placed on the storage chamber fluctuates through the main rope by displacing the height of the flying object. Thus, air may be fed into the bag-shaped structure body of the inflatable structure. In such a flying object raising system, the internal pressure of the bag-shaped structure body of the inflatable structure may be monitored. When the internal pressure falls below a predetermined pressure that is appropriately set, the height of the flying object is displaced. As a result, pumping operations of the pump are executed. The internal pressure of the bag-shaped structure body of the inflatable structure can be maintained at a predetermined pressure or more. This is convenient.

Thus, according to another aspect of the present disclosure, a flying object raising system is provided that includes
a flying object, of which a structure is an inflatable structure, and that is moored by a main rope from a ground surface and raised overhead,
a pump for pumping air into a bag-shaped structure body of the inflatable structure, and
an adjusting unit for adjusting a height of the flying object, in which
the pump includes
   a storage chamber that has a bag shape and that is made of an expandable and contractible flexible material for storing fluid,
   an expansion and contraction unit for expanding and contracting the storage chamber,
   an intake check valve that communicates with an interior of the storage chamber to only allow flow of fluid from outside of the storage chamber to inside of the storage chamber, and
   a discharge check valve that communicates with the interior of the storage chamber to only allow flow of fluid from the inside of the storage chamber to the outside of the storage chamber, in which
the pump is configured such that
   when the storage chamber is expanded by the expansion and contraction unit, fluid flows into the storage chamber through the intake check valve, and
   when the storage chamber is contracted by the expansion and contraction unit, fluid flows out from inside the storage chamber through the discharge check valve,
the expansion and contraction unit is linked to the main rope, and also is configured to apply deformation force to the storage chamber that varies with change in position of the flying object,
the pump is configured such that
   when the deformation force from the expansion and contraction unit is applied, the storage chamber is deformed and volume of the storage chamber decreases, and
   when the deformation force from the expansion and contraction unit is eased, the storage chamber is relaxed and the volume of the storage chamber increases,
the pump is configured such that expanding and contracting of the storage chamber feeds fluid into the bag-shaped structure body,
the adjusting unit for adjusting the height of the flying object includes a detecting unit for detecting internal pressure of the bag-shaped structure body, and
the flying object raising system is configured such that, when the internal pressure of the bag-shaped structure body falls below a predetermined value, the flying object is moved up or down, and is configured such that fluid is accordingly fed into the bag-shaped structure body by the pump.

Thus, according to the present disclosure, there is provided a pump that is suitable for injecting air into a bag-shaped structure body of an inflatable structure. The main component of the pump of the present disclosure is a storage chamber that has a bag shape and that is made of an expandable and contractible flexible material, and is relatively flexible, and can be configured so as not readily to damage outer skin of the bag-shaped structure body even when rubbing against the outer skin. Further, deformation force by the expansion and contraction unit for expanding and contracting the storage chamber can be applied by any technique. The expansion and contraction unit may be linked to a main rope by which the inflatable structure is moored, such that the deformation force is applied by changing the position of the inflatable structure, or the like. A system in which the pumping operations of air are executed without direct power supply can be configured. The pump of the present disclosure may be utilized to increase or maintain the internal pressure of bag-shaped structure bodies that are inflated with air and are used continuously over a certain period of time, such as of structures in general, for example, building structures such as dome roofs and disaster evacuation shelters, road structures such as pylons, traffic regulating members, and so forth, toys, playground equipment, and objects, that are filled with air and expanded, such as balls, structures and wings of moving bodies such as inflatable kites, inflatable boats, and so forth.

Other objects and advantages of the present disclosure will become apparent from the following description of preferred embodiments of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a pump according to the present embodiment;

FIG. 2A is a schematic diagram illustrating the operation of a pumping system according to this embodiment.

FIG. 2B is a schematic view illustrating an operation of a pump according to an embodiment of the present disclosure;

FIG. 3A is a schematic view of a system for lifting a flying object to which a pump according to an embodiment of the present disclosure is applied; and

FIG. 3B are schematic diagrams of the temporal variation of the tension Ft acting on the jacket tube of the pump.

### DETAILED DESCRIPTION OF EMBODIMENTS

The disclosure will now be described in detail in accordance with some preferred embodiments with reference to the accompanying drawings, in which: In the drawings, the same reference numerals denote the same parts.

### Configuration of the Pump

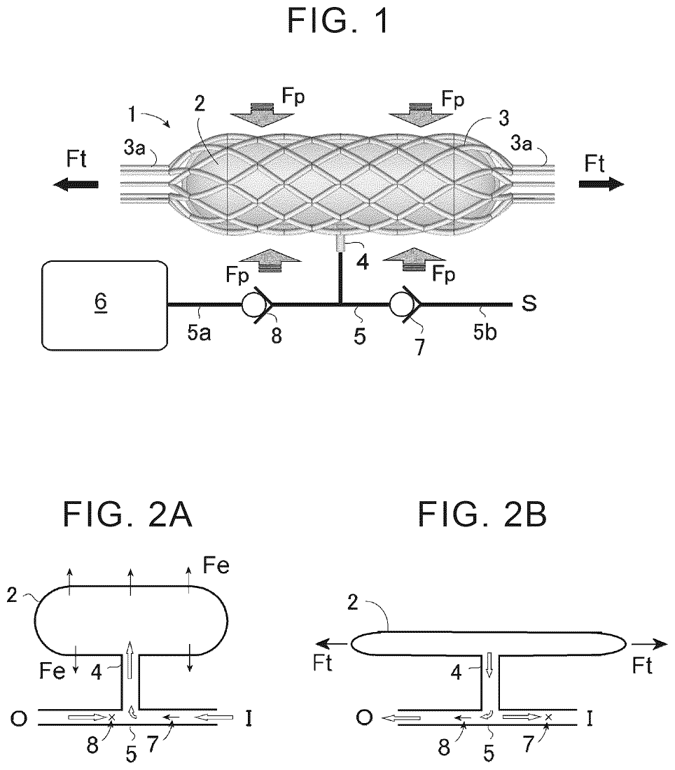

As shown in FIG. 1, the pump 1 according to the present embodiment is a bag-shaped structure body formed of a flexible elastic material having a cylindrical shape, an elliptical spherical shape, or a spindle shape. The pump 1 includes a bladder (storage chamber) 2, a jacket tube 3, a fluid tube 5, an intake check valve 7, and a discharge check valve 8. The bladder (storage chamber) 2 can store a fluid therein. The jacket tube 3 may be a tube configured to surround the bladder 2. The fluid tube 5 is connected to the inlet/outlet 4 communicating with the inside of the bladder 2. Any fluid, such as air, water, etc., flows through the fluid tube 5. The intake check valve 7 allows only the flow of fluid from one end of the fluid tube 5 to the inlet/outlet 4. The discharge check valve 8 allows only the flow of fluid from the inlet/outlet 4 to the other end of the fluid tube 5.

In the above configuration, the bladder 2 may be formed of any elastic material such as a stretchable rubber material having strength capable of withstanding the internal pressure during the storage of the fluid in the storage chamber. The bladder 2 is formed in such a manner as to form a cylindrical, elliptical, or spindle-shaped space therein when no external force such as tension or compressive force is applied from the surroundings. The jacket tube 3 may be in the form of a tube that telescopically surrounds the bladder 2 and is configured to contract the bladder 2 when the jacket tube 3 extends longitudinally, as described below. Typically, the jacket tube 3 may be, for example, a mesh tube, as shown. In this case, the direction of the mesh is a direction inclined with respect to the longitudinal direction of the jacket tube 3. As a result, when the jacket tube 3 is pulled in both end directions in the longitudinal direction, the diameter shrinks. The end 3a of the jacket tube 3 are connected to any type of feature. When an external force Ft for extending the jacket tube 3 in the longitudinal direction is applied, a force Fp in the direction of reducing the diameter acts on a part between both end 3a of the jacket tube 3. The bladder 2 inside the jacket tube 3 is also reduced. The jacket tube 3 may be formed of any material that allows its expansion and contraction, such as plastic materials (polyester, polyethylene, nylon, etc.), carbon fibers, steel fibers, etc. The fluid tube 5 connected to the inlet/outlet 4 in communication with the inside of the bladder 2 may be a tubular member formed of a conventional material used in this field, and as shown, the intake check valve 7 and the discharge check valve 8 are disposed across the connection with the inlet/outlet 4 of the fluid tube 5. The intake check valve 7 and the discharge check valve 8 may be check valves that allow fluid of a conventional mode used in this field to flow in only one direction. The upstream 5b of the intake check valve 7 in the fluid tube 5 may be connected to a source S of fluid to be pumped by the pump 1, and if such fluid is air, it may be open to the atmosphere. The downstream side 5a of the discharge check valve 8 in the fluid tube 5 is connected to the fluid destination and, when the pump is used to increase or maintain the internal pressure of the inflatable structure, is communicated with the interior of the bag-shaped structure body 6 of the inflatable structure, as shown.

### Operation of the Pump

In the operation of the pump 1 according to the present embodiment, in brief, the fluid is pumped in one direction by reducing and enlarging the diameter of the jacket tube 3 by increasing or decreasing the external force Ft acting on both end 3a of the jacket tube 3 as shown in FIG. 1. More specifically, first, when the external force Ft is not applied to both end 3a of the jacket tube 3 or is low, the inner diameter of the bladder 2 increases due to the elastic force Fe of the outer wall thereof, and the volume in the bladder 2 becomes large, as shown in FIG. 2A. In this case, when the diameter of the bladder 2 increases, the fluid flows into the bladder 2, and the flow of the fluid into the bladder 2 is allowed only in the intake check valve 7, so that the fluid flows into the bladder 2 from the end I connected to the fluid supply source. Next, when the external force Ft is increased on both end 3a of the jacket tube 3, the force Fp (FIG. 1) for reducing the diameter of the jacket tube 3 exceeds the elastic force Fe for increasing the diameter of the bladder 2. As a result, the diameter of the bladder 2 is reduced as shown in FIG. 2B. As a result, the volume in the bladder 2 is contracted. At this time, since the fluid stored in the bladder 2 can only flow through the discharge check valve 8, the fluid is pumped to the supply destination of the fluid, for example, the end O connected to the inside of the bag-shaped structure body 6 of the inflatable structure. After that, when the external force Ft is reduced on both end 3a of the jacket tube 3, the inner diameter expands due to the elastic force Fe of the outer wall of the bladder 2, and the volume in the bladder 2 expands, as shown in FIG. 2A. In this case, as described above, since the fluid can flow only from the intake check valve 7, the fluid flows into the bladder 2 from the end I connected to the fluid supply source. Then, when the increase or decrease of the external force Ft to both end 3a of the jacket tube 3 as described above is repeated, the jacket tube 3 repeatedly decreases and increases in diameter. As a result, the contraction and expansion of the bladder 2 are repeated, and the fluid is pumped from the supply source to the supply destination via the inside of the bladder 2.

In the case of the pump 1 of the present embodiment described above, the bladder 2 and the jacket tube 3 surrounding it are relatively flexible and lack a rigid housing such as a conventional compressor. It is advantageous in that the outer skin is less likely to be damaged even when the outer skin of the bag-shaped structure body 6 is rubbed against the outer skin when the inflatable structure is folded. In addition, the pumping operation of the pump may be achieved by applying a pulling force to both end 3a of the jacket tube 3, and thus, for example, by attaching both end 3a of the jacket tube 3 to any mechanisms so that their separation and proximity are repeated. Therefore, no power supply is required for the pump itself. The power supply may not be located in the vicinity of the pump. Pump 1 of the present embodiment is advantageous when it is desirable to make the equipment involved in the pump as lighter as possible, such as when it is installed in a flying object or a main rope securing it, in order to increase or maintain the internal pressure of the inflatable structure of the flying object being elevated overhead in the flying object elevation system described later.

### Configuration and Operation of Flying Object Lifting System

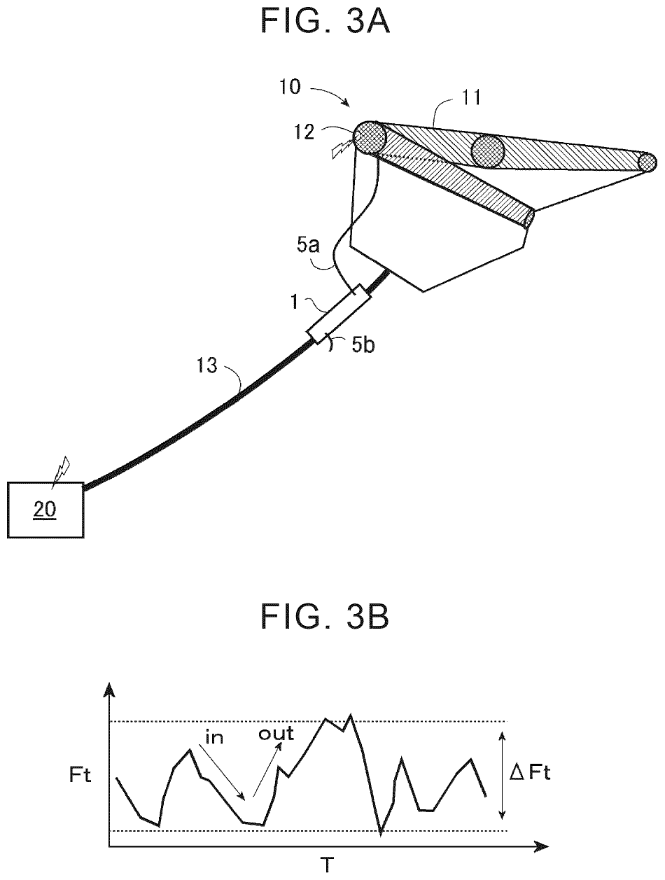

As described above, the pump of the present embodiment may be incorporated into the main rope 13 or the like that moors the kite 10 in order to increase or maintain the inflatable structure employed in the kite structure in the kite lifting system (flying object lifting system) as schematically illustrated in FIG. 3A. The kite lifting system lifts overhead the kite 10 (flying object) moored by the main rope 13 to the mooring device 20 installed on a ground surface or the like. In the illustrated configuration, the jacket tube 3 of the pump 1 is incorporated into the main rope 13. The downstream side 5a of the discharge check valve 8 of the fluid tube 5 linked to the inlet/outlet 4 of the bladder 2 is communicated with the inside of the inflatable structure 11 of the kite 10. The upstream b of the intake check valve 7 of the fluid tube 5 is opened to the atmosphere. The inflatable structure 11 may be provided with a sensor device 12 that detects the internal pressure, and may be configured to transmit a detection value of the internal pressure to the mooring device 20. According to the above-described configuration, the tension of the main rope 13 fluctuates as the height of the kite 10 rises and falls. As a result, as shown in FIG. 3B, the traction force Ft between both ends of the jacket tube of the pump-1 changes, and the deformation force of the bladder by the jacket tube changes. In and out of the bladder are triggered and thus the inflatable structure 11 is aerated.

In the above-described kite lifting system, more preferably, various operations may be performed in accordance with the detection value of the sensor device 12 that detects the internal pressure of the inflatable structure 11 as described above. Specifically, first, when the detection value of the internal pressure sensor device 12 reaches the upper limit value of the internal pressure that may be appropriately set, the deformation of the jacket tube of the pump 1 may be suppressed. The upper limit of the internal pressure may be set to a value at which the internal pressure of the inflatable structure 11 is sufficient to maintain the shape of the inflatable structure 11. Suppression of the deformation of the mantle tube can be achieved by any type of mechanism that locks the spacing between the ends of the mantle tube (FIG. 1) in response to the detection value of the internal pressure sensor device 12 reaching the upper limit. When the detection value of the internal pressure sensor device 12 falls below the lower limit value of the internal pressure that may be set as appropriate, the distance between both ends of the jacket tube is varied actively or autonomously. Thus, air may be supplied from the pump 1 to the inflatable structure 11. The lower limit of the internal pressure may be set to a value that makes it difficult to maintain the shape of the inflatable structure 11 when the internal pressure of the inflatable structure 11 falls below the value. Variations in the spacing between the ends of the jacket tube can be achieved, for example, by varying the height of the kite 10 in any manner (changing the structure of the kite, changing the tension of the main rope 13, etc.). As shown in FIG. 3B, the change width in the volume of expanding and contracting of the storage chamber of the pump-1 may be adjusted so as to match the change width ΔFt of the tension Ft acting on the jacket tube from the main rope due to the elevation of the height of the kite 10.

When the pump 1 of the present embodiment is applied to the kite lifting system as described above, the pump 1 is relatively flexible and does not have a rigid housing as described above. When the inflatable structure 11 is folded, it is advantageous in that the outer skin is hardly damaged even if the outer skin is rubbed against the outer skin. Further, the pump 1 performs the pumping of air by the expansion and contraction of the jacket tube, since the power supply to the jacket tube itself is not required, it is not necessary to dispose the power supply device in the vicinity of the jacket tube, it is also advantageous in that it is possible to reduce the weight of the pump.

The foregoing description has been made in connection with the embodiments of the present disclosure. Many modifications and variations are readily possible to those skilled in the art. The disclosure is not limited to the embodiments illustrated above, but may be applied to various devices without departing from the inventive concept.

What is claimed is:

1. A pump that is configured to deliver fluid in one direction, the pump comprising:
a storage chamber that has a bag shape and that is made of an expandable and contractible flexible material for storing fluid;
an expansion and contraction unit for expanding and contracting the storage chamber;
an intake check valve that communicates with an interior of the storage chamber to only allow flow of fluid from outside of the storage chamber to inside of the storage chamber; and
a discharge check valve that communicates with the interior of the storage chamber to only allow flow of fluid from the inside of the storage chamber to the outside of the storage chamber, wherein
the pump is configured such that
when the storage chamber is expanded by the expansion and contraction unit, fluid flows into the storage chamber through the intake check valve, and
when the storage chamber is contracted by the expansion and contraction unit, fluid flows out from inside the storage chamber through the discharge check valve.

2. The pump according to claim 1, wherein
an outflow port of fluid in the discharge check valve is communicated into a bag-shaped structure body of an inflatable structure, and
the pump is configured to feed fluid into the bag-shaped structure body by expanding and contracting of the storage chamber.

3. The pump according to claim 1, wherein
the expansion and contraction unit is configured to apply deformation force to the storage chamber, and
the pump is configured such that
when the deformation force from the expansion and contraction unit is applied, the storage chamber is deformed and volume inside the storage chamber decreases, and
when the deformation force from the expansion and contraction unit is eased, the storage chamber is relaxed and the volume inside the storage chamber increases.

4. The pump according to claim 3, wherein
the expansion and contraction unit is linked to the inflatable structure, and
the pump is configured such that changing a position of the inflatable structure changes the deformation force that is applied to the storage chamber from the expansion and contraction unit, and the fluid is fed into the bag-shaped structure body.

5. A flying object raising system, comprising:
a flying object, of which a structure is an inflatable structure, and that is moored by a main rope from a ground surface and raised overhead;
a pump for pumping air into a bag-shaped structure body of the inflatable structure; and
an adjusting unit for adjusting a height of the flying object, in which the pump includes
a storage chamber that has a bag shape and that is made of an expandable and contractible flexible material for storing fluid,
an expansion and contraction unit for expanding and contracting the storage chamber,
an intake check valve that communicates with an interior of the storage chamber to only allow flow of fluid from outside of the storage chamber to inside of the storage chamber, and
a discharge check valve that communicates with the interior of the storage chamber to only allow flow of fluid from the inside of the storage chamber to the outside of the storage chamber,
the pump is configured such that
when the storage chamber is expanded by the expansion and contraction unit, fluid flows into the storage chamber through the intake check valve, and
when the storage chamber is contracted by the expansion and contraction unit, fluid flows out from inside the storage chamber through the discharge check valve,
the expansion and contraction unit is linked to the main rope, and also is configured to apply deformation force to the storage chamber that varies with change in position of the flying object,
the pump is configured such that
when the deformation force from the expansion and contraction unit is applied, the storage chamber is deformed and volume of the storage chamber decreases, and
when the deformation force from the expansion and contraction unit is eased, the storage chamber is relaxed and the volume of the storage chamber increases,
the pump is configured such that expanding and contracting of the storage chamber feeds fluid into the bag-shaped structure body,
the adjusting unit for adjusting the height of the flying object includes a detecting unit for detecting internal pressure of the bag-shaped structure body, and
the flying object raising system is configured such that, when the internal pressure of the bag-shaped structure body falls below a predetermined value, the flying object is moved up or down, and is configured such that fluid is accordingly fed into the bag-shaped structure body by the pump.
